(19) United States
(12) Patent Application Publication
(10) Pub. No.: US 2007/0058831 A1
(43) Pub. Date: Mar. 15, 2007

(54) Ear ring type two way wireless mini-ear piece

(76) Inventor: Jin Rie, Los Angeles, CA (US)

Correspondence Address: Eugene Oak, 110 N. Berendo St. #4, Los Angeles, CA, 90004, US

(21) Appl. No.: 11/224,638

(22) Filed: Sep. 13, 2005

(51) Int. Cl. H04R 25/00

(52) U.S. Cl. 381/374

(57) ABSTRACT

A two-way communication earpiece, which is a small and comfortable. The ear-piece is comprised of a main body, a sound delivery probe, and a micro probe for sound pick up. The sound delivery probe, which is extended from main body, is configured to be inside of the external acoustic meatus of a user. The main body is attached to lobule of ear of the user like an ear ring. The sound delivery probe is coated with silicon for hygiene of the external acoustic meatus of the user. The micro probe for sound pick up is attached to a junction point of user's skin that locates behind the ear of the user, where rear surface of the antihelix, rear surface of the lobule, and neck skin of the user meets. At that point the microprobe picks up the voice of the user from the vibration of the skin.

### 1. FIELD OF THE INVENTION

The invention relates to a two-way communication device, more specifically, to an earpiece which is configured to be attached to the lobule of the ear of a user.

### 2. BACKGROUND OF THE INVENTION

Known hands free telephone headsets generally include at least one earphone for delivering sounds and a microphone for sound pickup. The microphone is typically positioned near the user's mouth by a microphone boom which extends from the headset. The microphone is designed to pick up the user's voice and minimize pickup of background noise. The headset may be held in place on the head by a headband. Other types of headsets have an ear clip which attaches over the ear eliminating the need for a headband. However, these known headsets generally include a microphone positioned on a microphone boom. The microphone boom or the entire headset may be easily dislodged requiring the user to constantly correct their position. These known headsets are often heavy, cumbersome, bulky, and uncomfortable for long time use. The known headsets are also very noticeable. Some communication earpieces have been developed which do not include the conventional microphone boom or headband, however, these devices have similar drawbacks. It is the purpose of current application to provide an ear piece that is small, light, and not noticeable from apparent. The appearance of the ear piece of current application is designed like an earring.

### DESCRIPTION OF THE PRIOR ART

U.S. Pat. No. 6,681,022 to Puthuff, et al. illustrates a two-way communication earpiece that is a small, inconspicious, and comfortable to fit behind the ear for sound delivery and pickup. The sound pickup part, microphone, is located on the upper part of the main body. That position is between the upper portion of the notch in the concha of the user's ear and the head. Therefore, the picked-up sound is very week.

U.S. Pat. No. 5,627,802 to Langer illustrates a sound amplification system includes an amplifier and a waterproof microphone. That system is for use in the water to find and call fishes. Far from human communication.

U.S. Pat. No. 4,720,857 to Burris, et al. illustrates a miniaturized headset for two-way voice communication is supported and positioned by the notch in the concha portion of a wearer's ear. The headset is reversible and may be worn on either the left or right ear. That article is very similar to the U.S. Pat. No. 6,681,022 except the position of the sound pickup part, the microphone.

U.S. Pat. No. 5,737,436 to Boyden, U.S. Pat. Nos. 5,488,668 and 5,278,912 to Waldhauer, U.S. Pat. No. 5,276,739 to Krokstad, et al., U.S. Pat. Nos. 5,201,007 and 5,031,219 to Ward, et al., U.S. Pat. Nos. 5,201,006 and 5,033,090 to Weinrich, U.S. Pat. No. 4,904,078 to Gorike, U.S. Pat. No. 4,869,339 to Barton, U.S. Pat. No. 4,090,040 to Berland, and U.S. Pat. No. 3,975,599 to Johanson illustrate hearing aids of various kind that have microphone and speaker in a small body that are to be placed in the outer ear.

U.S. Pat. No. 5,365,595 to Li illustrates a sealed microphone assembly that includes a microphone, a microphone housing having a cavity being resonant at an audio frequency range, and a sealing membrane.

U.S. Pat. No. 4,570,746 to Das, et al. illustrates an effective wind/breath screen for a microphone is described. The wind/breath screen includes a rigid perforated structure for enclosing the microphone. The microphone being physically isolated from the rigid perforated structure by a surrounding pad of air therebetween.

U.S. Pat. No. 4,450,930 to Killion illustrates a microphone, particularly for hearing aid application, said microphone providing a stepped response characteristic relative to frequency wherein low frequency sounds will couple to the associated hearing aid with a restricted amount of amplification, while providing an emphasis or higher amplification for the higher frequencies in the bandwidth of interest.

U.S. Pat. No. 4,392,025 to Tamamura, et al. illustrates a condenser microphone in which a back electrode, disposed oppositely to the rear surface of a diaphragm, and a circuit assembling plate disposed oppositely to the rear surface of the back electrode, are held in a holder.

Irrespective of the abundant amount of prior art about two way communication and hearing aids, none of them discloses a two way communication system that is attached to a user's lobule of ear and pick up the speaking sound of the user from the vibration of skin that locates behind the ear of the user.

### SUMMARY OF THE INVENTION

Many communication earpieces have been developed which do not include the conventional microphone boom or headband, however, these devices have some drawbacks. These known earpieces are often heavy, cumbersome, bulky, and uncomfortable for long time use. The known earpieces are also very noticeable. It is the purpose of current application to provide an ear piece that is small, light, and not noticeable from apparent. The appearance of the ear piece of current application is designed like an earring. The two-way communication earpiece of the current application is a small and comfortable earpiece which is attachable to the lobule of a user. The earpiece may be used with a communication device, such as cellular telephones and two-way radios. The earpiece has a sound delivery probe, configured to be inside of the external acoustic meatus of a user, which is extending from main body. The main body is attached to lobule of ear of the user like ear ring. The sound delivery probe is coated with silicon for hygiene of the external acoustic meatus of the user. A micro probe for microphone is attached to a junction point of user's skin that locates behind the ear of the user, where rear surface of the antihelix, rear surface of the lobule, and neck skin of the user meets. At that point the microprobe picks up the voice of the user from the vibration of the skin.

### BRIEF DESCRIPTION OF THE DRAWINGS

FIG. 1 is a perspective view of an ear ring type two way wireless mini-ear piece of the current application.

FIG. 2 is an exploded perspective view of the ear ring type two way wireless mini-ear piece of the current application.

FIG. 2-a is an exploded perspective view of a spare part ear ring type two way wireless mini ear piece of the current application.

FIG. 3 is a perspective view of the ear ring type two way wireless mini-ear piece of the current application worn on lobule of an ear of a user.

FIG. 4 is a rear view of the ear ring type two way wireless mini-ear piece of the current application worn on lobule of an ear of a user.

FIG. 5 is a front cross-sectional view of the ear ring type two way wireless mini-ear piece of the current application worn on an ear of a user showing the sound delivery probe reach into the inside of the external acoustic meatus of a user.

### DETAILED DESCRIPTION OF THE PREFERRED EMBODIMENTS

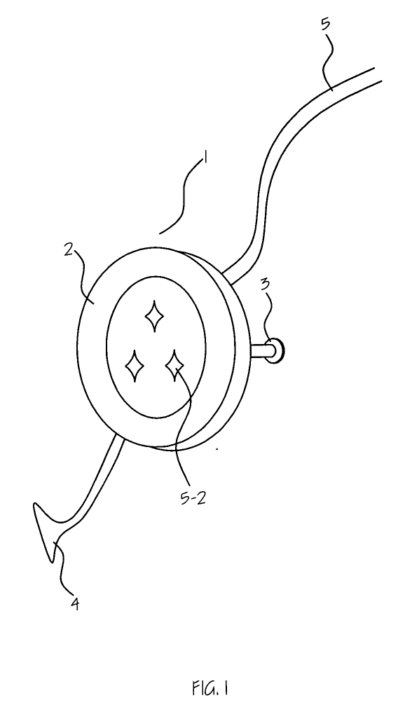

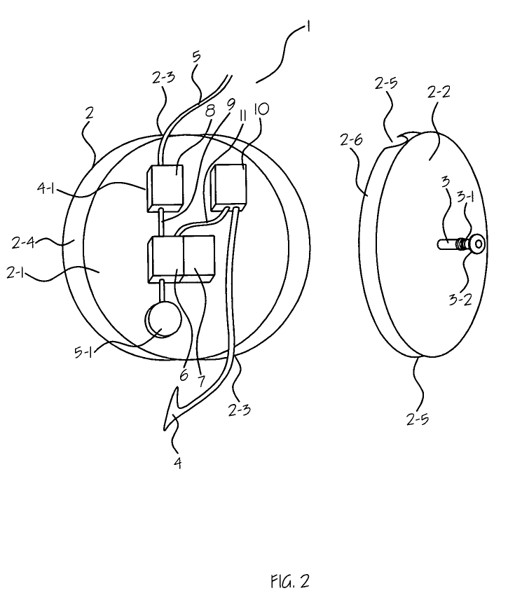

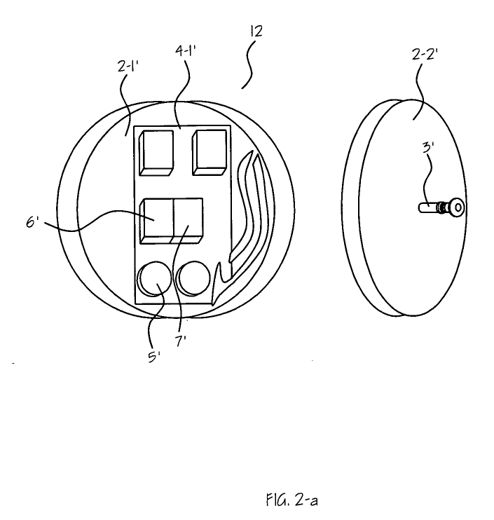

FIG. 1 is a perspective view of an ear ring type two way wireless mini-ear piece (1) of the current application. The earpiece (1) according to the present invention is comprised of an earring shape main body (2), an ear fixing member (3) for pierced ear, a skin attaching microphone probe (4), and a sound delivery probe (5). FIG. 2 is an exploded perspective view of the earring type two way wireless mini-ear pieces (1) of the current application. The main body (2) of the earring type mini-ear piece is comprised of a slim case (2-1) and a case cover (2-2). Two half holes (2-3) are developed on the two opposite site of the case wall (2-4). Another two half holes (2-5) are developed on the two opposite site of the cover wall (2-6). When the case (2-1) and cover (2-2) are assembled, the half holes (2-3) and (2-5) over-lapped and form two holes on the opposite wall site of the main body (2). An ear fixing member (3) is soldered on the outer-surface of the cover (2-2). Outer tip (3-1) of the ear fixing member (3) is fabricated as a screw for engaging to the nut (3-2). Electronic compartments are installed inside of the case (2-1) by fixing on a plate (4-1). A small battery of size 5 A (5-1) is connected to a printed circuit board for sound amplification (6) and to another circuit board for wire less signal in-put and out-put (7) via a power switch (5-2). The power switch (5-2) is connected to the sound amplification circuit board (6) and has an apparent of jewelry. The power switch (5-2) can also control the volume. The printed circuit board for sound amplification (6) is connected to a sound transducer (8) by an electrical connection (9). A flexible sound delivery probe (5) is connected to the sound transducer (8). A microphone assembly (10) is connected to the printed circuit board for sound amplification (6) by another electric connector (11). The flexible microphone probe (4) is connected to the microphone assembly (10). The flexible microphone probe (4) and the sound delivery probe (5) are made of same material of skin colored plastic such as silicon, Tygon®, urethane, Nylon®, and flexible PVC (Poly Vinyl Chloride).

FIG. 2-a is an exploded perspective view of a spare part ear ring type two way wireless mini ear piece (12) of the current application. The spare part ear piece (12) is provided with the main ear piece (1) as one pair. The apparent shape of the spare part piece (12) is the same as the main body (2). The spare part ear piece (12) is also comprised of a slim case (2-1′) and a case cover (2-2′). When the case (2-1′) and cover (2-2′) are assembled, it becomes an earring look like body. An ear fixing member (3′) is soldered on the outer-surface of the cover (2-2′). Two small batteries of size 5 A (5-1′), a sound amplification (6′) circuit board, a circuit board for wire less signal in-put and out-put (7′), a sound transducer (8′) and a micro-phone assembly (10′) are provided as spare electronic compartments installed inside of the case (2-1′) by fixing on a plate (4-1′). A flexible microphone probe (4′) and a sound delivery probe (5′) are also stored inside of the spare part ear piece (12). Wear these two bodies, (2) and (12), on each ear of a user makes other people believe that the user is wearing ear rings.

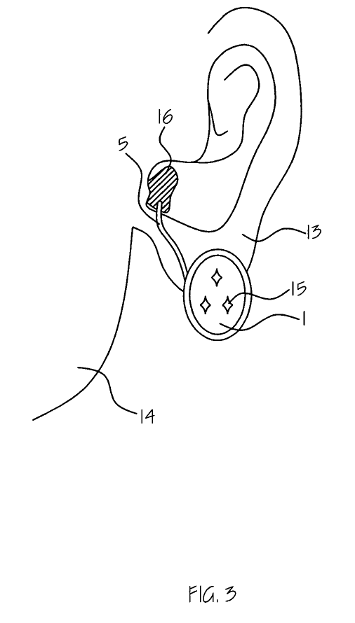

FIG. 3 is a perspective view of the ear ring type two way wireless mini-ear piece (1) of the current application worn on a lobule (13) of an ear of a user (14). The mini-ear piece (1) faces outward. Due to the decorative surface (15), the piece looks like an ear ring. The sound delivery probe (5) is hiding behind the mini-ear piece (1) and is put into the external acoustic meatus (16) of a user (14).

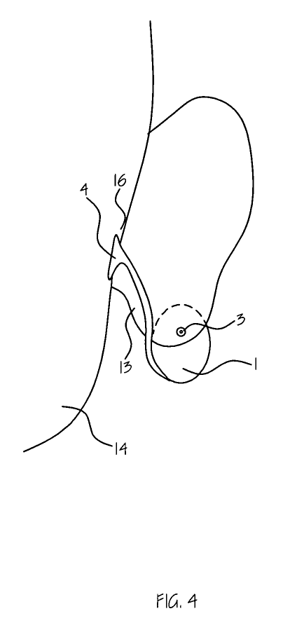

FIG. 4 is a rear view of the ear ring type two way wireless mini-ear piece of the current application (1) worn on a lobule of an ear of a user (14). The mini-ear piece (1) is fixed to the lobule (13) of the user (14) by the ear fixing member (3). A skin attaching microphone probe (4) is attached to the skin of the user (14) that is located just behind and inner side of the rear edge of the jaw bone. That place is hidden by the lobule (13) of the user (14).

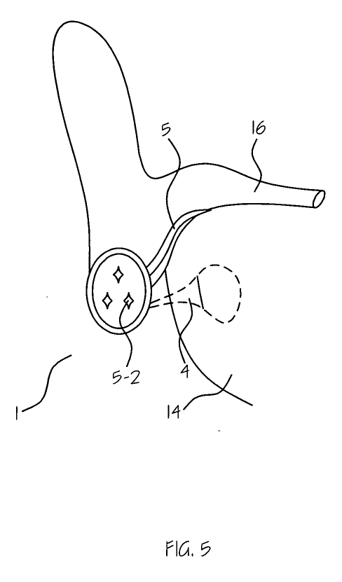

FIG. 5 is a front cross-sectional view of the ear ring type two way wireless mini-ear piece (1) of the current application worn on an ear of a user showing the sound delivery probe (5) reach into the inside of the external acoustic meatus (16) of a user (14).

When a user (14) wears the ear ring type two way wireless mini-ear piece (1) of the current application, the user must wear the mini-ear piece to one of the lobule (13) of the user (14) via the ear fixing member (3) and attach the microphone probe (4) to the skin of the user (16) that is located just behind and inner side of the rear edge of the jaw bone. Small amount of Vaselin® grease helps the probe (4) sticks to the point. The sound delivery probe (5) is inserted into the external acoustic meatus (16) of the user. Turn on the mini-ear piece (1) by turning the power switch (5-2) and control volume. A message from other person who wears the other mini-ear piece (1) is received by the circuit board for wireless signal in-put and out-put (7) and amplified in the printed circuit board for sound amplification (6). The amplified signal is transferred to the sound transducer (8) and changed into sound. The sound is transferred to the external acoustic meatus (16) of the user (14) via the sound delivery probe.

When the user (14) speaks, the sound is picked up as a vibration of the skin, which locates just behind and inner side of the rear edge of the jaw bone, by the skin attaching microprobe. The sound is delivered to the microphone assembly (10). The microphone assembly (10) changes the sound into electric signals and transfer to the circuit board for sound amplification (6) to amplify the signal. The amplified signal is transferred to the circuit board for wireless signal in-put and out-put (7) and is sent out the to other mini-ear piece.

This patent will cover all the claims, which can be easily imagined or derived from this main application. For example, this application for bilateral communications through rearing type microphone and hearing aid also include any unilateral communications probably with less part.

In unilateral communication devices, the speaking partner does not have to carry hearing aid device, whereas the hearing partner does not have to carry any micro-phone device. This partial application will be easily available by reducing some parts of each device per partner. This unilateral communication application has some merits. One of them is that the speaking partner can wear the lighter and more fashionable earring type microphone at her earlobe, whereas the hearing partner does not have to wear earring at all but instead just keep the hearing aid inside of his ear meatus.

What is claimed is:

1. An ear ring type two way wireless mini-ear piece wearing on a lobule of an ear of a user that is comprised of;
an earring shape main body that is comprised of;
a slim case having two half holes that are developed on the two opposite site thereof, and
a case cover having another two half holes developed on the two opposite site of the wall to form two holes when the case and the cover are assembled; and
an ear fixing member for pierced ear that is soldered on the outer-surface of the cover and the outer tip is fabricated as a screw for engaging to a nut, and
a set of electronic compartments which are installed inside of the case by fixing on a plate on a comprised of;
a sound transducer, and
a printed circuit board for sound amplification electrically connected to the sound transducer by an electric connection, and
a microphone assembly that is connected to the printed circuit board for sound amplification by an electric connector, and
a circuit board for wire less signal in-put and out-put, and
a power switch for control volume having an apparent of jewelry that is connected to the sound amplification circuit board, and
a small battery of size 5 A that is connected to the printed circuit board for sound amplification and to the circuit board for wire less signal in-put and out-put via a power switch, and
a sound delivery probe which is made of flexible material of skin colored plastic and one end of which is connected to the sound transducer and the other end is inserted into the external acoustic meatus of the user, and
a microphone probe which is made of the same flexible material of skin colored plastic and one end of which is connected to the microphone assembly and the other end is attached to the skin of the user that is located just behind and inner side of the rear edge of the jaw bone.
